(19) United States
(12) Patent Application Publication
(10) Pub. No.: US 2026/0217520 A1
(43) Pub. Date: Jul. 30, 2026

(54) MODULAR HORSE BIT SYSTEM

(71) Applicant: Katherine Brewer, Hörstel (DE)

(72) Inventor: Katherine Brewer, Hörstel (DE)

(21) Appl. No.: 19/462,949

(22) Filed: Jan. 28, 2026

Related U.S. Application Data
(60) Provisional application No. 63/750,761, filed on Jan. 28, 2025.

(51) Int. Cl. B68B 1/06

(52) U.S. Cl. CPC B68B 1/06

(57) ABSTRACT

A modular horse bit is disclosed. A modular horse bit may include a first mouthpiece and a second mouthpiece. The first mouthpiece may include a first sleeve defining a first internal channel. A first hook may comprise a first hook shank configured to extend through the first internal channel. The first hook shank may have a first threaded portion at one end and a curved hook portion at an opposite end. A first end cap may comprise a first hole with internal threads configured to engage with the first threaded portion. A first cheek piece may be removably connected to the first mouthpiece. The second mouthpiece may include corresponding components. The curved hook portion of the first hook and the curved hook portion of the second hook may be configured to engage with one another to connect the first mouthpiece to the second mouthpiece.

### BACKGROUND

Horse bits have been used for centuries as a crucial component of equestrian equipment, allowing riders to communicate with and control their horses. A bit typically consists of a mouthpiece that sits in the horse's mouth, connected to cheek pieces on either side that attach to the bridle and reins. Over time, various types of bits have been developed to suit different riding disciplines, horse sensitivities, and training needs.

The two main categories of bits are snaffle bits and curb bits. Snaffle bits operate with direct pressure on the horse's mouth, while curb bits use leverage to amplify the rider's signals. Within these categories, there exists a wide array of designs, including different mouthpiece shapes, materials, and cheek piece configurations.

Selecting the appropriate bit for a horse can be a complex process, as each animal may respond differently to various bit designs. Factors such as the horse's age, training level, mouth conformation, and intended use all play a role in determining the most suitable bit. Additionally, a horse's needs may change over time, requiring piece adjustments to the bit configuration.

Traditionally, equestrians have addressed these challenges by maintaining a collection of different bits, often through a process of trial and error to find the best fit for each horse. However, this approach can be costly and time-consuming, as purchasing multiple complete bits can represent a significant investment.

Furthermore, the inability to easily modify individual components of a bit limits the flexibility in fine-tuning the equipment to a horse's specific needs. This limitation can potentially hinder the training process and the overall comfort and performance of the horse.

As equestrian sports continue to evolve, there is a growing demand for equipment that can be more readily customized to meet the unique requirements of each horse and rider combination. This desire for personalization extends to all aspects of tack, including the critical area of biting.

### SUMMARY

A modular horse bit may comprise a first sleeve and a second sleeve. The modular horse bit may comprise a first hook having a first shank that extends through the first sleeve. The modular horse bit may comprise a second hook having a second shank that extends through the second sleeve. The first hook and the second hook may be sized and configured to engage with one another. The modular horse bit may comprise a first end cap that can be threaded to an end of the first hook. The modular horse bit may comprise a second end cap that can be threaded to an end of the second hook. The modular horse bit may comprise a first cheek piece coupled with the first hook shank. The modular horse bit may comprise a second cheek piece coupled with the second hook shank.

A modular horse bit may comprise a first mouthpiece. The first mouthpiece may comprise a first sleeve defining a first internal channel extending through at least a portion of a length of the first sleeve. The first mouthpiece may comprise a first hook comprising a first hook shank configured to extend through the first internal channel. The first hook shank may have a first threaded portion at one end and a curved hook portion at an opposite end. The first mouthpiece may comprise a first end cap comprising a first hole with internal threads configured to engage with the first threaded portion of the first hook shank. The first mouthpiece may comprise a first cheek piece having a first cheek piece opening. The first cheek piece may be removably connected to the first mouthpiece. The modular horse bit may comprise a second mouthpiece. The second mouthpiece may comprise a second sleeve defining a second internal channel extending through at least a portion of a length of the second sleeve. The second mouthpiece may comprise a second hook comprising a second hook shank configured to extend through the second internal channel. The second hook shank may have a second threaded portion at one end and a curved hook portion at an opposite end. The second mouthpiece may comprise a second end cap comprising a second hole with internal threads configured to engage with the second threaded portion of the second hook shank. The second mouthpiece may comprise a second cheek piece having a second cheek piece opening. The second cheek piece may be removably connected to the second mouthpiece. The curved hook portion of the first hook and the curved hook portion of the second hook may be configured to engage with one another to connect the first mouthpiece to the second mouthpiece.

A kit for modular horse bit may comprise a first mouthpiece. The first mouthpiece may comprise a first sleeve defining a first internal channel extending through at least a portion of a length of the first sleeve. The first mouthpiece may comprise a first hook comprising a first hook shank sized to extend through the first internal channel. The first hook shank may have a first threaded portion at one end and a curved hook portion at an opposite end. The first mouthpiece may comprise a first end cap comprising a first hole with internal threads sized and configured to engage with the first threaded portion of the first hook shank. The first mouthpiece may comprise a first cheek piece having a first cheek piece opening. The first cheek piece may be configured to be removably connected to the first mouthpiece. The kit may comprise a second mouthpiece. The second mouthpiece may comprise a second sleeve defining a second internal channel extending through at least a portion of a length of the second sleeve. The second mouthpiece may comprise a second hook comprising a second hook shank sized to extend through the second internal channel. The second hook shank may have a second threaded portion at one end and a curved hook portion at an opposite end. The second mouthpiece may comprise a second end cap comprising a second hole with internal threads sized and configured to engage with the second threaded portion of the second hook shank. The second mouthpiece may comprise a second cheek piece having a second cheek piece opening. The second cheek piece may be configured to be removably connected to the second mouthpiece.

This summary and the following detailed description are examples of the teachings of this disclosure and are not restrictive.

### BRIEF DESCRIPTION OF FIGURES

Non-limiting and non-exhaustive examples are described with reference to the following figures.

FIG. 1 is perspective view of a modular horse bit.

FIG. 2 is perspective view of a modular horse bit.

FIG. 3 is an exploded illustration of a mouthpiece.

FIG. 4 is a perspective view of a modular horse bit with the first sleeve and second sleeve shown as transparent

FIG. 5 is a perspective view of the first hook engaged with the second hook.

FIG. 6 shows a mouthpiece without an end cap.

FIG. 7 is a perspective view of a sleeve and an end cap of a mouthpiece.

FIG. 8 is a perspective view of a modular hose bit with a link element.

FIG. 9 is perspective view of a modular horse bit.

FIG. 10 is perspective view of a modular horse bit.

FIG. 11 is perspective view of a modular horse bit.

### DETAILED DESCRIPTION

A number of examples of a modular horse bit are disclosed. The disclosed modular horse bit can provide a degree of customization and adaptability in the configuration of horse bits.

In one example, a modular horse bit may include two mouthpieces and two cheek pieces, with the two bit pieces can have a modular construction.

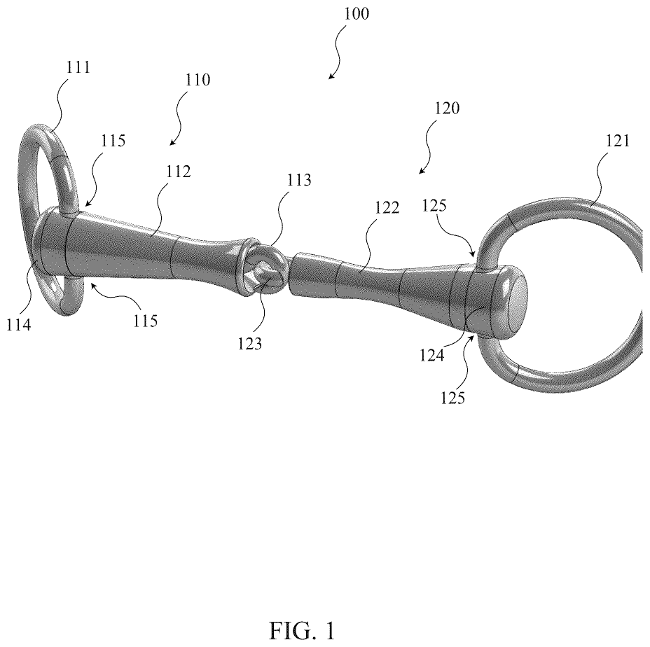

FIG. 1 is a perspective view of a modular horse bit 100 in an assembled configuration. The modular horse bit 100 may include a first mouthpiece 110 and a second mouthpiece 120. As shown, the first mouthpiece 110 is on a left side of the modular horse bit 100, and the second mouthpiece 120 is positioned on a right side of the modular horse bit 100. The first mouthpiece 110 and the second mouthpiece 120 may be connected at a central region of the modular horse bit 100 via a first hook 113 and a second hook 123.

The first mouthpiece 110 may include a first sleeve 112. The first sleeve 112 may have a generally cylindrical body that tapers toward a central joint region. In this example, the first sleeve 112 extends from an outer end toward the central region where the first mouthpiece 110 connects to the second mouthpiece 120. A first end cap 114 may be positioned at an outer end of the first sleeve 112.

A first cheek piece 111 may be attached to the outer end of the first mouthpiece 110. The first cheek piece 111 may be circular in shape with a small opening that is smaller than a diameter of the first cheek piece 111. The first cheek piece 111 may be configured to receive a reign. The first cheek piece 111 may be removably connected to the first mouthpiece 110.

The first hook 113 may be positioned at an inner end of the first sleeve 112. The first hook 113 may be located near the central joint region. The first hook 113 may provide a connection interface between the first mouthpiece 110 and the second mouthpiece 120.

The second mouthpiece 120 may include a second sleeve 122. The second sleeve 122 may have a generally cylindrical body that tapers toward the central joint region. In this example, the second sleeve 122 extends from an outer end toward the central region where the second mouthpiece 120 connects to the first mouthpiece 110. A second end cap 124 may be positioned at an outer end of the second sleeve 122.

A second cheek piece 121 may be attached to the outer end of the second mouthpiece 120. The second cheek piece 121 may be circular in shape with a small opening that is smaller than a diameter of the second cheek piece 121. The second cheek piece 121 may be configured to receive a reign. The second cheek piece 121 may be removably connected to the second mouthpiece 120.

The second hook 123 may be positioned at an inner end of the second sleeve 122. The second hook 123 may be located near the central joint region. The second hook 123 may provide a connection interface between the first mouthpiece 110 and the second mouthpiece 120.

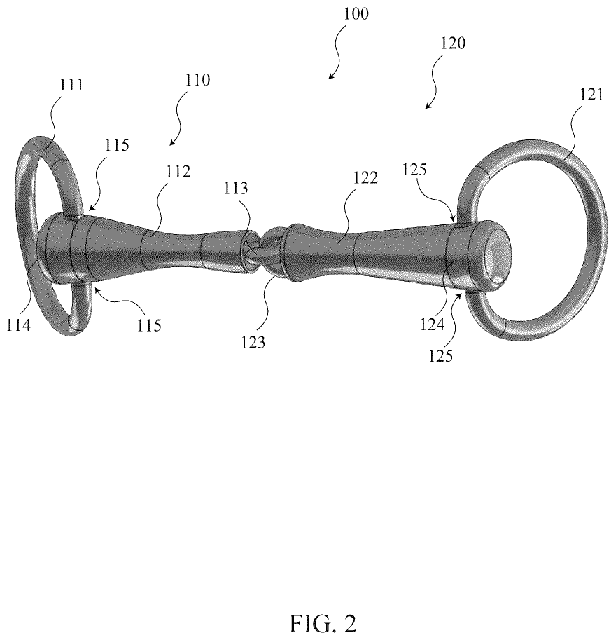

FIG. 2 shows another view of the modular horse bit 100.

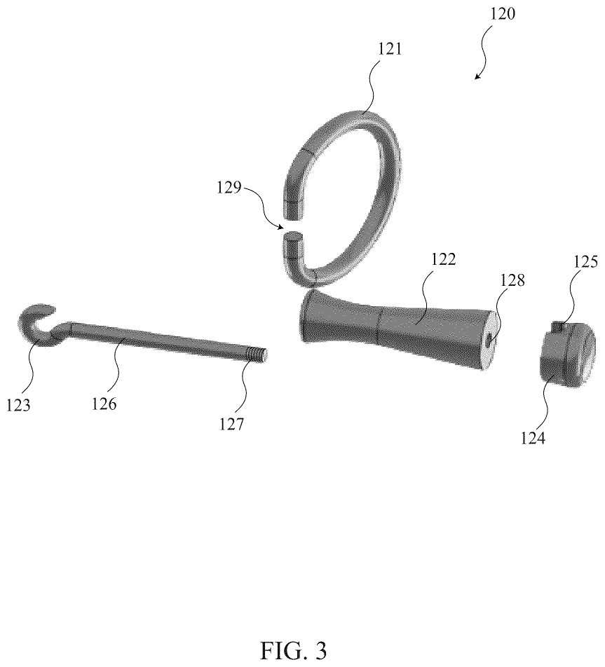

FIG. 3 is an exploded illustration of a second mouthpiece 120. While the second mouthpiece 120 is shown, a first mouthpiece 110 may include similar features or components.

The second mouthpiece 120 may be shown in a disassembled state to illustrate the individual components that form the second mouthpiece 120. The second mouthpiece 120 may include the second sleeve 122, the second hook 123, the second end cap 124, and the second cheek piece 121. Each of these components may be separable from one another to allow for modular assembly and disassembly.

The second sleeve 122 may form the main body of the second mouthpiece 120. The second sleeve 122 may have a generally cylindrical shape with a flared or hourglass-like central region. The second sleeve 122 may taper toward both ends. The second sleeve 122 may define a second internal channel 128 that extends through at least a portion of its length.

The second hook 123 may include a second hook shank 126 that, when assembled, extends through the second internal channel 128. The second hook shank 126 may be a long, slender rod-like element. The second hook shank 126 may have a generally straight shaft portion. The second hook shank 126 may terminate in a curved or hooked portion at its left end forming the second hook 123. This hooked portion may be configured to engage with the first hook 113 of the first mouthpiece 110.

The other end of the second hook shank 126 includes a second threaded portion 127. The second threaded portion 127 may comprise external threads formed on the surface of the second hook shank 126. The second threaded portion 127 may be configured to engage with corresponding internal threads within the second end cap 124. The threaded connection may allow the second hook 123 to extend through the second sleeve 122 and be removably attached to the second end cap 124.

The second end cap 124 may be a separate short cylindrical piece having diameter substantially similar to the diameter of the second sleeve 122. In the figure, the second end cap 124 may be positioned to the right of the second sleeve 122 in the exploded view. The second end cap 124 may include a second hole 152 with internal threads that allow it to be secured with the second threaded portion 127 of the second hook 123.

The second cheek piece 121 is shown above the second sleeve 122 in the exploded view. The second cheek piece 121 may be substantially circular in shape although it may have any shape. The second cheek piece 121 may have a second cheek piece opening 129 (or gap) at one location along its circumference. At the 192//the cheek piece may also have a two cheek piece ends on either side of the second cheek piece opening 129. This gap may form a C-shape or open cheek piece configuration. The second cheek piece opening 129 may allow the second cheek piece 121 to be opened slightly for attachment to or removal from the second end cap 124. The second cheek piece opening 129, for example, may have an opening between the two ends of the second cheek piece 121 that is larger than the diameter of the second hook shank 126 and smaller than the diameter of the second end cap 124.

The second cheek piece 121 may be configured to slide onto the second end cap 124 or to be captured between the second end cap 124 and the second sleeve 122 when assembled. The second end cap 124 may also include a threaded slot that is sized and configured to thread with the second threaded portion 127 of the second hook shank 126 when extended through the second sleeve 122.

The second end cap 124 may also include second detents 125. The second detents 125 may include a detent on each side of the second end cap 124. Each of the second detents 125 may have a dimension that is sized and configured to receive the end of the second cheek piece 121.

When assembled, the second hook shank 126 is slide into one end of the second internal channel 128 of the second sleeve 122. The second threaded portion 127 may extend from the other end of the second internal channel 128 and may be threaded with threads of the second end cap 124 while the two ends of the second cheek piece 121 are placed within second detents 125. As the second end cap 124 is rotated and threaded with the second threaded portion 127, the second hook 123 is pulled toward the second sleeve 122. When the second hook 123 is engaged with the first hook 113, as shown in FIG. 1 and FIG. 2, and the second end cap 124 is rotated and threaded with the second threaded portion 127, the second hook 123 and the first hook 113 are linked together as shown in FIG. 1 and FIG. 2.

The exploded view of FIG. 3 may illustrate the modular nature of the second mouthpiece 120. Each component may be separately manufactured, assembled, and/or exchanged for other components. The modular construction may allow different components to be interchanged to customize the characteristics of the modular horse bit 100. For example, different second sleeves 122 with varying diameters, materials, or textures may be selected and assembled with a second hook 123, a second end cap 124, and a second cheek piece 121. As another example, different second end cap 124 with varying diameters, materials, or textures may be selected and assembled with a same second hook 123, a second sleeve 122, and a second cheek piece 121.

As another example, a different second end cap 124 with varying diameters, materials, or textures may be selected and assembled with a same second hook 123, a second sleeve 122, and a second cheek piece 121.

The second cheek piece 121 may rotate at the second detents 125 about an axis perpendicular to an axis of the second sleeve 122 and/or the second hook shank 126. The first cheek piece 111 may rotate at the first detents 115 about an axis perpendicular to an axis of the first sleeve 112 and/or the first hook shank 116.

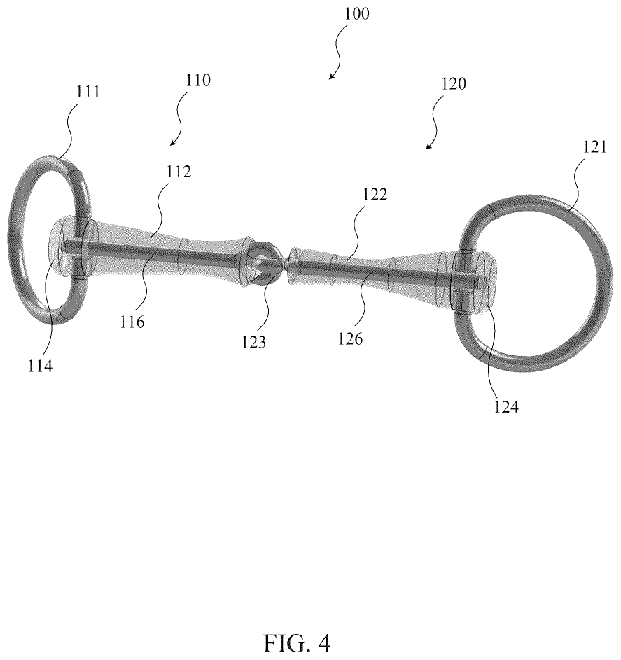

FIG. 4 is a perspective view of a modular horse bit 100 in an assembled configuration with the first sleeve 112 and second sleeve 122 shown as transparent which shows the second hook shank 126 extending through the second sleeve 122 and the first hook shank 116 extending through the first sleeve 112.

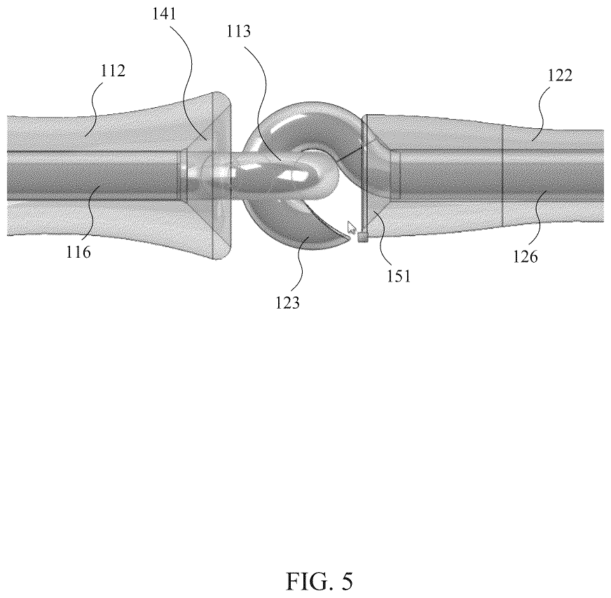

FIG. 5 is a perspective view of the first hook 113 engaged with the second hook 123. The first sleeve 112 includes a first tapered pocket 141 on end surface of the first sleeve 112. When the first end cap 114 is threaded into the first hook shank 116 the hook of the first hook 113 is pulled into the first tapered pocket 141. The second sleeve 122 includes a second tapered pocket 151 on end surface of the second sleeve 122. When the second end cap 124 is threaded into the second hook shank 126 the hook of the second hook 123 is pulled into the second tapered pocket 151. The second tapered pocket 151 may be concave.

When the hook of the second hook 123 is pulled into the second tapered pocket 151, the opening in the hook is partially covered by the end surface of the second sleeve 122. When the hook of the first hook 113 is pulled into the first tapered pocket 141, the opening in the hook is partially covered by the end surface of the first sleeve 112. This allows the hooks to be engaged in such a way that the two may pivot relative to each other without the possibility of the other hook sliding out of the gap in the hook. Typically, the gap in each hook is slightly larger (e.g., 2%, or 5% or 10% larger) than the diameter of the hook or hook shank so that the two hooks may be engaged with each other. But when engaged, the gap is obstructed by the end surface of the sleeve which does not allow the hooks to be disengaged.

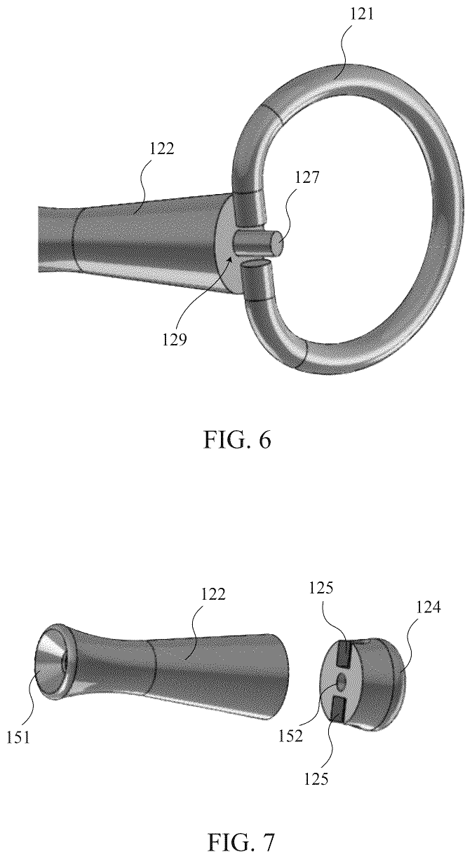

FIG. 6 shows the second mouthpiece 120 without the second end cap 124. As shown, the second cheek piece opening 129 is larger than the diameter of the second threaded portion 127 of the second hook shank 126 and smaller than the diameter of the second end cap 124 or the end surface of the second sleeve 122. The first mouthpiece 110 may have a similar configuration.

FIG. 7 shows a view of the second sleeve 122 and the second end cap 124 of the second mouthpiece 120. As shown, an end surface of the second end cap 124 includes the second hole 152 and the second detents 125. FIG. 7 also shows the second tapered pocket 151 in the second sleeve 122. The first mouthpiece 110 may have a similar configuration with a similar first tapered pocket.

The first mouthpiece 110 and the second mouthpiece 120 may have the same configuration. Any component or feature discussed in relation to the second mouthpiece 120 or the first mouthpiece 110 may also be a component or feature of the other mouthpiece.

FIG. 8 is a perspective view of a modular hose bit 100 with a link element 180, which may be positioned between the first mouthpiece 110 and the second mouthpiece 120.

The link element 180 may be coupled with the first hook 113 and the second hook 123. The link element 180 may provide an alternative connection mechanism between the first mouthpiece 110 and the second mouthpiece 120. The link element 180 may comprise a central body portion with a first hole 181 and a second hole 182 that are sized and configured to couple with the first hook 113 and the second hook 123.

The link element 180, for example, may allow for articulation between the first mouthpiece 110 and the second mouthpiece 120. The link element 180, for example, may extend the length of the modular horse bit 100.

The link element 180 may permit relative movement between the first mouthpiece 110 and the second mouthpiece 120 during use. The link element 180 may be removably coupled to the first hook 113 and the second hook 123. The link element 180 may be formed from a metal material. The link element 180 may have a generally elongated shape.

The first hook 113 may be configured to engage with a first side of the link element 180. The second hook 123 may be configured to engage with a second side of the link element 180. The engagement between the first hook 113 and the link element 180 may allow for rotational movement. The engagement between the second hook 123 and the link element 180 may allow for rotational movement. The link element 180 may provide a pivot point between the first mouthpiece 110 and the second mouthpiece 120.

The overall assembly 100 may maintain the same general configuration as shown in other figures, with the first cheek piece 111 and the second cheek piece 121 positioned at opposite ends of the modular horse bit 100. The modular horse bit 100 with the link element 180 may provide an alternative joint configuration that may offer different articulation characteristics compared to a direct hook-to-hook engagement.

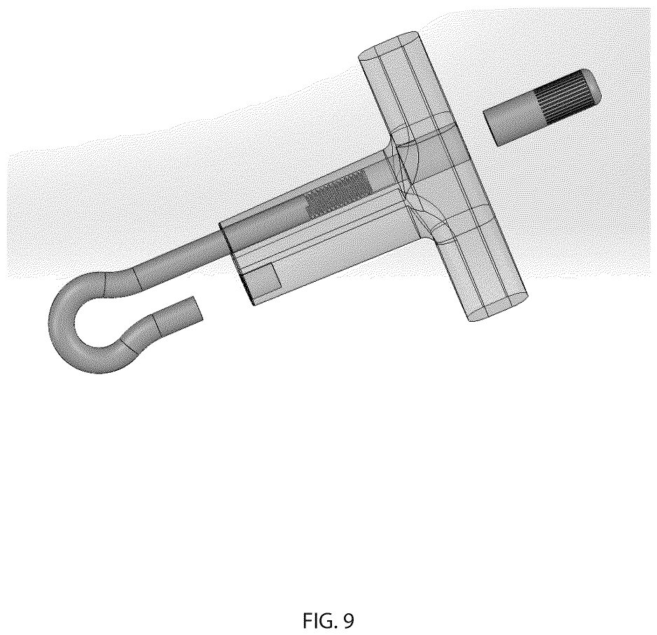

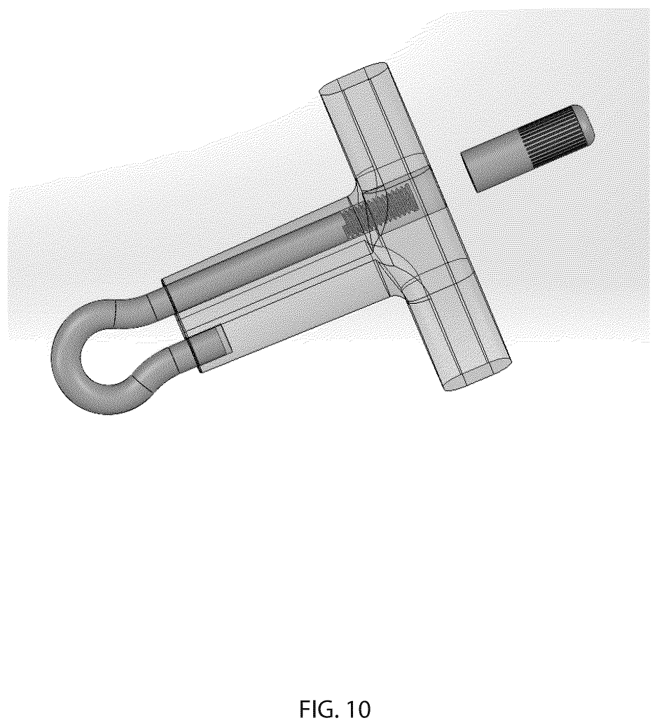

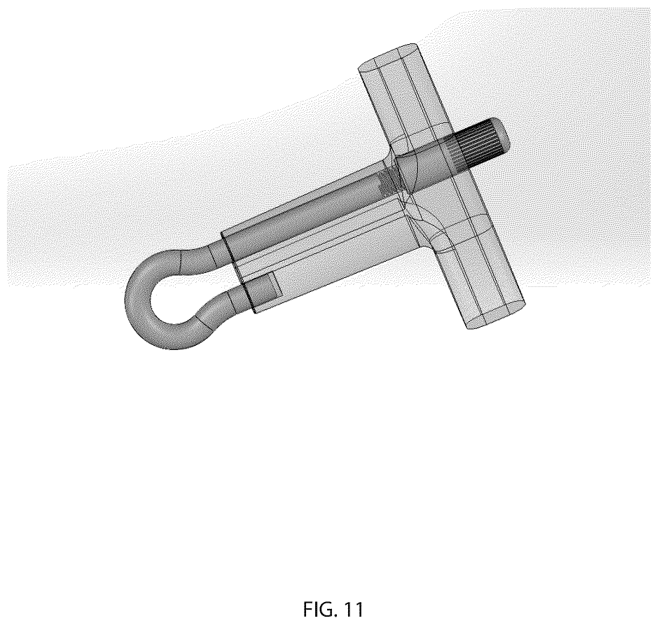

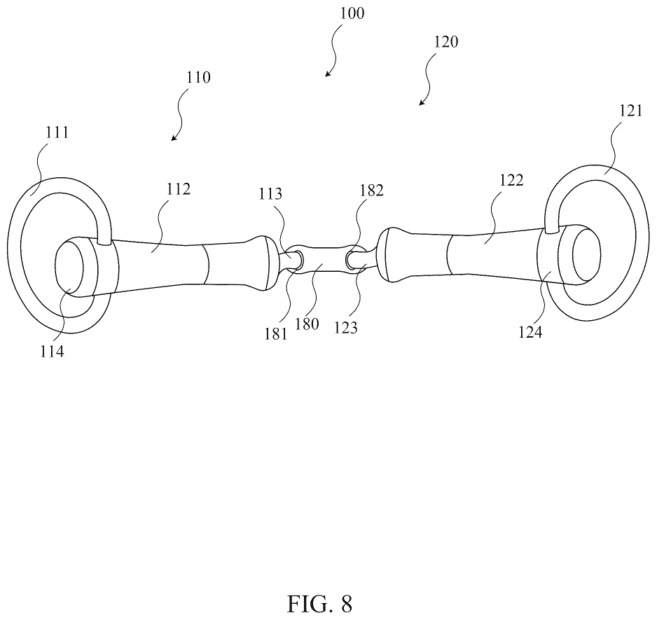

FIG. 9, FIG. 10 and FIG. 11 show different examples of a modular horse bit.

FIG. 9 is a perspective view of a modular horse bit. The mouthpiece may comprise a central piece that is removably connected to two bar pieces. In some cases, the central piece and the bar pieces may be configured with threaded screw connections, creating a strong and secure connection that can be easily assembled and disassembled as needed. This allows for the central piece to be replaced or interchanged with other central pieces of different designs or constructions, providing a high degree of customization in the configuration of the mouthpiece.

The modular horse bit may also include two cheek pieces, each of which may be removably connected to one of the bar pieces. In some aspects, each bar piece may define a bore that is configured to receive a part of one of the cheek pieces. This connection may be designed to securely hold the cheek piece in place while allowing for easy removal and replacement when necessary. This feature further enhances the modularity of the system, enabling the cheek pieces to be interchanged with other cheek pieces of different designs or configurations.

In some cases, the cheek pieces may include a retractable or spring-loaded section that can be reversibly inserted into the bore of the bar pieces. This design may provide a secure connection between the cheek pieces and the bar pieces while allowing for easy assembly and disassembly of the components. This feature may be particularly useful in situations where the cheek pieces need to be frequently replaced or interchanged, such as when adjusting the bit configuration to suit different horses or riding styles.

The modular design of the horse bit system allows for a high degree of customization and adaptability in the configuration of the bit. By providing a variety of interchangeable components, the system enables the user to easily modify the bit configuration to suit specific requirements, potentially reducing the need for multiple complete bits. This innovative approach to bit design and assembly offers potential benefits in terms of cost-effectiveness, convenience, and the overall comfort and performance of the horse.

Referring to FIG. 9, the bottom drawing provides a detailed view of a connection mechanism, labeled as “screw in.” This mechanism appears to be a threaded or screw-type connection, likely used to join the different modular components of the bit system. In some cases, the bar pieces and the central piece may be configured with threaded screw connections to create a suitable strong connection. This allows for the central piece to be replaced or interchanged with other central pieces of different designs or constructions, providing a high degree of customization in the configuration of the mouthpiece.

In some aspects, each cheek piece may comprise a retractable or spring-loaded section configured to be reversibly inserted into the bore of one of the bar pieces. This design may provide a secure connection between the cheek pieces and the bar pieces while allowing for easy assembly and disassembly of the components. This feature may be particularly useful in situations where the cheek pieces need to be frequently replaced or interchanged, such as when adjusting the bit configuration to suit different horses or riding styles.

The modular horse bit may also be provided as a kit, including a variety of interchangeable components such as different central pieces, bar pieces, and cheek pieces, along with instructions for assembly and selection. In some cases, the central pieces may comprise a single joint or a double joint. The selection of a central piece from a plurality of central pieces having different constructions allows for customization of the bit to suit the specific needs of the horse and rider. Similarly, the selection of two bar pieces from a plurality of bar pieces having different designs allows for further customization of the bit. The modular design of the system allows for the easy modification and replacement of individual components, facilitating the fine-tuning of the bit configuration to suit specific requirements.

Referring to FIG. 9, the process of assembling the modular horse bit may involve selecting two cheek pieces from a plurality of cheek pieces having different configurations. In some cases, the cheek pieces may be selected based on the specific needs or preferences of the horse or rider. For example, the cheek pieces may be selected based on their size, shape, material, or other characteristics. Once the cheek pieces have been selected, they may be removably connected to the bar pieces of the mouthpiece. This connection may be achieved through various mechanisms, such as threaded screw connections, bores, or spring-loaded sections, as described above.

The assembly process may also involve removably connecting the central piece to the two bar pieces to form the mouthpiece. This connection may be achieved through a similar mechanism as the connection between the cheek pieces and the bar pieces. For example, the central piece and the bar pieces may be configured with threaded screw connections, creating a strong and secure connection that can be easily assembled and disassembled as needed. This allows for the central piece to be replaced or interchanged with other central pieces of different designs or constructions, providing a high degree of customization in the configuration of the mouthpiece.

In some aspects, the central piece, bar pieces, and cheek pieces may each be made with any suitable material. For example, these components may be made of metal, such as brass, silver, or stainless steel. In other cases, the components may be made of hard plastic or elastomeric material. The selection of the material for the components may depend on various factors, such as the specific needs or preferences of the horse or rider, the intended use of the bit, or other considerations.

In some cases, the central piece may comprise a single joint or a double joint. The selection of a central piece with a single joint or a double joint may depend on the specific needs or preferences of the horse or rider. For example, a central piece with a single joint may be selected for a horse that is comfortable with a bit that creates a nutcracker effect on the tongue, bar, and lips. On the other hand, a central piece with a double joint may be selected for a horse that prefers a bit that reduces the nutcracker action.

In some aspects, at least one of the cheek pieces may comprise a shank. The shank may be adjustable in length, allowing for customization of the leverage for a specific rider or horse. For example, a longer shank may be selected for a rider who prefers a bit with greater leverage, while a shorter shank may be selected for a rider who prefers a bit with less leverage. The shank may be adjusted by various mechanisms, such as a pin system that allows for adjusting the length and width of the shanks. This feature further enhances the modularity of the system, enabling the shanks to be interchanged with other shanks of different lengths or configurations.

FIG. 10 is a perspective view of a modular horse bit. In some cases, the central piece of the mouthpiece may comprise a single joint or a double joint. The selection of a central piece with a single joint or a double joint may depend on the specific needs or preferences of the horse or rider. For example, a central piece with a single joint may be selected for a horse that is comfortable with a bit that creates a nutcracker effect on the tongue, bar, and lips. On the other hand, a central piece with a double joint may be selected for a horse that prefers a bit that reduces the nutcracker action.

In some aspects, at least one of the cheek pieces may comprise a shank. The shank may be adjustable in length, allowing for customization of the leverage for a specific rider or horse. For example, a longer shank may be selected for a rider who prefers a bit with greater leverage, while a shorter shank may be selected for a rider who prefers a bit with less leverage. The shank may be adjusted by various mechanisms, such as a pin system that allows for adjusting the length and width of the shanks. This feature further enhances the modularity of the system, enabling the shanks to be interchanged with other shanks of different lengths or configurations.

In some cases, the cheek pieces may include telescoping shanks for adjustable leverage ratios. This design allows for the length of the shank to be easily adjusted, providing a high degree of customization in the configuration of the bit. The telescoping shanks may be particularly useful in situations where the leverage ratio needs to be frequently adjusted, such as when adapting the bit configuration to suit different horses or riding styles.

The figure also illustrates an “Interchangeable Hackamore Kit (shanks).” This kit may include a variety of shanks of different lengths and configurations, along with a pin system that allows for adjusting the length and width of the shanks. The interchangeable hackamore kit further enhances the modularity of the system, providing additional options for customization and adaptability in the configuration of the bit.

FIG. 11 is a perspective view of a modular horse bit. This method may involve a series of steps that allow for the selection and customization of the bit components based on the specific needs or preferences of the horse and rider.

In some aspects, the method may begin with the selection of a central piece from a plurality of central pieces having different constructions. The central piece may be selected based on various factors, such as the specific needs or preferences of the horse or rider, the intended use of the bit, or other considerations. For example, a central piece with a single joint may be selected for a horse that is comfortable with a bit that creates a nutcracker effect on the tongue, bar, and lips. On the other hand, a central piece with a double joint may be selected for a horse that prefers a bit that reduces the nutcracker action.

The method may also involve the selection of two bar pieces from a plurality of bar pieces having different designs. The bar pieces may be selected based on various factors, such as the size or shape of the horse's mouth, the specific needs or preferences of the horse or rider, the intended use of the bit, or other considerations. For example, bar pieces with a wider width may be selected for a horse with a larger mouth, while bar pieces with a narrower width may be selected for a horse with a smaller mouth.

In some cases, the method may further involve the selection of two cheek pieces from a plurality of cheek pieces having different configurations. The cheek pieces may be selected based on various factors, such as the specific needs or preferences of the horse or rider, the intended use of the bit, or other considerations. For example, cheek pieces with a longer shank may be selected for a rider who prefers a bit with greater leverage, while cheek pieces with a shorter shank may be selected for a rider who prefers a bit with less leverage.

Once the central piece, bar pieces, and cheek pieces have been selected, the method may involve removably connecting the central piece to the two bar pieces to form the mouthpiece. This connection may be achieved through various mechanisms, such as threaded screw connections, bores, or spring-loaded sections, as described above. The method may also involve removably connecting each of the two cheek pieces to one of the bar pieces. This connection may be achieved through a similar mechanism as the connection between the central piece and the bar pieces.

In some aspects, the method may further involve adjusting a length of a shank on at least one of the selected cheek pieces to customize leverage for a specific rider or horse. This adjustment may be achieved through various mechanisms, such as a pin system that allows for adjusting the length and width of the shanks. This feature further enhances the modularity of the system, enabling the shanks to be interchanged with other shanks of different lengths or configurations.

In some cases, the method may also involve selecting a curb strap or chain from a plurality of curb straps or chains, and removably attaching the selected curb strap or chain to the cheek pieces. The curb strap or chain may be selected based on various factors, such as the specific needs or preferences of the horse or rider, the intended use of the bit, or other considerations.

Through this method, the modular horse bit allows for a high degree of customization and adaptability in the configuration of the bit, potentially reducing the need for multiple complete bits and allowing for easier adaptation to different horses or riding styles.

In some aspects, the central piece, bar pieces, and cheek pieces of the modular horse bit may be made from a variety of materials, each offering piece unique properties and benefits for different applications. For instance, these components may be made of metal, such as brass, silver, or stainless steel. These metals are known for their durability and strength, making them suitable for use in horse bits that are subjected to significant pressure and wear.

In some cases, the components may be made of hard plastic. Hard plastic components may offer a balance of strength and lightness, potentially making the bit more comfortable for the horse. In other cases, the components may be made of elastomeric material. Elastomeric materials, such as rubber or silicone, may provide a softer, more flexible option that can be more comfortable for the horse's mouth.

In some embodiments, the components of the modular horse bit may be made from titanium alloys. Titanium alloys are known for their lightweight strength and corrosion resistance, making them an excellent choice for horse bit components that need to withstand the rigors of use while minimizing the weight in the horse's mouth.

In other embodiments, the components may be made from carbon fiber reinforced polymers. These materials offer a high strength-to-weight ratio, providing strong, durable components that are lighter than their metal counterparts. This can potentially reduce the weight of the bit, making it more comfortable for the horse.

In some cases, bioplastics derived from renewable resources may be used to manufacture the components of the modular horse bit. Bioplastics offer an eco-friendly option that can reduce the environmental impact of the horse bit production process.

In some embodiments, the components may feature silicone rubber coatings on metal parts. Silicone rubber is known for its softness and flexibility, and a coating of this material on metal components can improve the comfort of the bit for the horse. This can be particularly beneficial in the mouthpiece components, which come into direct contact with the sensitive tissues of the horse's mouth.

In each of these cases, the selection of material for the components of the modular horse bit may depend on various factors, such as the specific needs or preferences of the horse or rider, the intended use of the bit, or other considerations. By offering piece a range of material options, the modular horse bit provides a high degree of customization, enabling the user to select the most appropriate materials for their specific requirements.

In some aspects, the modular horse bit may employ various innovative connection mechanisms that facilitate quick assembly, secure attachment, and easy adjustability of components. These mechanisms may be designed to provide a balance of strength, ease of use, and flexibility, catering to the diverse needs and preferences of horse riders and trainers.

In some cases, the system may utilize magnetic connections for quick assembly and disassembly of components. For instance, neodymium magnets, known for their strong magnetic properties, may be incorporated into the design of the central piece, bar pieces, and cheek pieces. These magnets may allow for the components to be easily attached and detached, facilitating quick and convenient assembly and disassembly of the bit.

In other cases, the system may employ bayonet-style locking mechanisms for secure, tool-free connections between components. These mechanisms, commonly used in various types of hardware, may involve a male component with one or more radial lugs and a female component with matching slots. The components may be connected by inserting the male component into the female component and then rotating it to lock the lugs into the slots. This design may provide a secure connection that can be easily assembled and disassembled without the need for additional tools.

In some aspects, the system may incorporate snap-fit connections for easy replacement of components. These connections may involve components with complementary shapes that allow for them to be quickly snapped together or apart. This design may facilitate the easy replacement of worn or damaged components, enhancing the longevity and usability of the bit.

In other aspects, the system may utilize dovetail joints for precise alignment and stability between components. These joints, often used in woodworking and metalworking, may involve a trapezoidal or wedge-shaped tenon (the “dovetail”) on one component and a matching mortise or recess on another component. The components may be connected by sliding the dovetail into the mortise. This design may provide a strong and stable connection that resists being pulled apart.

In some cases, the system may employ quick-release pins for rapid adjustment of shank length or cheek piece style. These pins, commonly used in various types of hardware, may involve a pin with a handle or button that can be quickly inserted or removed. This design may allow for the shank length or cheek piece style to be easily adjusted, providing a high degree of customization in the configuration of the bit.

In each of these cases, the selection of connection mechanism may depend on various factors, such as the specific needs or preferences of the horse or rider, the intended use of the bit, or other considerations. By offering piece a range of connection options, the modular horse bit provides a high degree of customization, enabling the user to select the most appropriate mechanisms for their specific requirements.

In some aspects, the mouthpiece of the modular horse bit may incorporate additional innovative features designed to enhance comfort, functionality, and feedback for both the horse and rider. For instance, the mouthpiece may include interchangeable flavor inserts. These inserts may be designed to release a flavor that is appealing to the horse, encouraging acceptance of the bit. The flavor inserts may be made from a variety of materials, such as flavored rubber or plastic, and may be available in a range of flavors, such as apple, mint, or carrot. The flavor inserts may be removably attached to the central piece or bar pieces of the mouthpiece, allowing for easy replacement or interchangeability.

In some cases, the mouthpiece may feature an adjustable port height mechanism. This mechanism may allow for the height of the port in the central piece to be adjusted, providing customizable tongue relief for the horse. The adjustable port height mechanism may involve a port that is slidably or pivotally mounted on the central piece, and may be adjusted by various means, such as a screw mechanism, a lever mechanism, or a spring-loaded mechanism.

In some aspects, the mouthpiece may incorporate integrated pressure sensors. These sensors may be designed to provide feedback on the action of the bit, such as the amount of pressure being applied to the horse's mouth. The pressure sensors may be of various types, such as strain gauges, piezoelectric sensors, or capacitive sensors, and may be connected to a display or indicator that provides a visual or auditory signal corresponding to the pressure level. This feature may provide valuable feedback to the rider, helping to improve communication with the horse and enhance riding performance.

In some cases, the mouthpiece may feature textured surfaces with variable patterns. These textures may be designed to provide different sensory effects for the horse, potentially enhancing comfort and acceptance of the bit. The textures may be formed on the surfaces of the central piece or bar pieces, and may include various patterns, such as ridges, grooves, bumps, or waves. The textures may be formed by various methods, such as molding, machining, or 3D printing.

In some aspects, the mouthpiece may incorporate a hollow core design. This design may reduce the weight of the mouthpiece without compromising its strength, potentially making the bit more comfortable for the horse. The hollow core may be formed in the central piece or bar pieces, and may be of various shapes, such as cylindrical, conical, or rectangular. The hollow core design may be particularly beneficial in cases where lightweight materials, such as titanium alloys or carbon fiber reinforced polymers, are used for the components of the mouthpiece.

In some aspects, the cheek pieces of the modular horse bit may include interchangeable weight inserts. These weight inserts may be designed to adjust the balance of the bit, potentially enhancing the comfort and performance of the horse. The weight inserts may be made from various materials, such as metal, ceramic, or dense plastic, and may be available in a range of weights. The weight inserts may be removably attached to the cheek pieces, allowing for easy replacement or interchangeability.

In some cases, the cheek pieces may feature integrated rein guides. These rein guides may be designed to maintain the optimal position of the reins, potentially improving the control and communication between the rider and the horse. The rein guides may be formed on the surfaces of the cheek pieces, and may include various shapes, such as loops, hooks, or channels. The rein guides may be formed by various methods, such as molding, machining, or 3D printing.

In some aspects, the cheek pieces may incorporate pivoting attachment points. These attachment points may be designed to provide improved flexibility and comfort for the horse, potentially enhancing the acceptance of the bit. The pivoting attachment points may be located at the connections between the cheek pieces and the bar pieces, and may allow for the cheek pieces to pivot or rotate relative to the bar pieces. This feature may be particularly beneficial in cases where the horse has a sensitive mouth or requires a bit with a high degree of flexibility.

In some cases, the cheek pieces may include modular add-on slots. These slots may be designed to accommodate various training aids or accessories, such as curb chains, lip straps, or bit guards. The add-on slots may be formed on the surfaces of the cheek pieces, and may include various shapes, such as grooves, channels, or holes. The add-on slots may be formed by various methods, such as molding, machining, or 3D printing.

In some aspects, the components of the modular horse bit may be made from antimicrobial copper alloys. These alloys are known for their ability to kill bacteria and other microbes on contact, potentially enhancing the hygiene of the bit. The use of antimicrobial copper alloys may be particularly beneficial in cases where the bit is shared between multiple horses, as it may help to prevent the spread of diseases. The antimicrobial copper alloys may be used for various components of the bit, such as the central piece, bar pieces, or cheek pieces.

In some aspects, the modular horse bit may further comprise a curb strap or chain. The curb strap or chain may be removably attachable to the cheek pieces of the bit. This feature may provide additional control and leverage during riding, and may be particularly beneficial in cases where the bit is used with a curb or shank bit. The curb strap or chain may be made from various materials, such as leather, nylon, or metal, and may be available in a range of sizes and styles. The curb strap or chain may be attached to the cheek pieces by various means, such as hooks, loops, or clips, and may be easily removed or replaced as needed.

In some cases, the modular horse bit may be provided with instructions for selecting and assembling the central piece, bar pieces, and cheek pieces. These instructions may guide the user in choosing the appropriate components based on the specific needs or preferences of the horse or rider, and in assembling the components to form the bit. The instructions may be provided in various formats, such as printed manuals, online guides, or video tutorials, and may include diagrams, photographs, or other visual aids to assist the user in the assembly process.

In some aspects, the modular horse bit may be provided as a kit, which may further comprise a storage box configured to hold the plurality of central pieces, bar pieces, and cheek pieces. The storage box may be designed to organize and protect the components, facilitating their storage and transport. The storage box may be made from various materials, such as plastic, metal, or wood, and may include various features, such as compartments, dividers, or foam inserts, to securely hold the components. The storage box may also include a lid or cover, and may be lockable for added security. This feature may be particularly beneficial in cases where the modular horse bit is used by professional riders or trainers, who may need to transport the components between different locations or events.

A number of implementations have been described. Nevertheless, it will be understood that various modifications may be made without departing from the spirit and scope of the disclosure. Accordingly, other implementations are within the scope of the following claims.

That which is claimed is:

1. A modular horse bit, comprising:
a first sleeve
a second sleeve
a first hook having a first shank that extends through the first sleeve;
a second hook having a second shank that extends through the second sleeve,
wherein the first hook and the second hook are sized and configured to engage with one another;
a first end cap that can be threaded to an end of the first hook;
a second end cap that can be threaded to an end of the second hook;
a first cheek piece coupled with first hook shank; and
a second cheek piece coupled with the second hook shank.

2. The modular horse bit according to claim 1, wherein the first cheek piece and the second cheek piece are C-shaped.

3. The modular horse bit according to claim 1, wherein:
the first cheek piece includes a cheek piece opening and two cheek piece ends;
the second cheek piece includes a cheek piece opening and two cheek piece ends;
the first end cap includes two detents that are sized and configured to accept the two cheek piece ends of the first cheek piece; and
the second end cap includes two detents that are sized and configured to accept the two cheek piece ends of the second cheek piece.

4. The modular horse bit according to claim 1, wherein
the first cheek piece includes a cheek piece opening that is smaller than a diameter of the first end cap; and
the second cheek piece includes a cheek piece opening that is smaller than a diameter of the second end cap.

5. The modular horse bit according to claim 1, wherein
the first cheek piece includes a cheek piece opening that is larger than a diameter of the first shank; and
the second cheek piece includes a cheek piece opening that is larger than a diameter of the second shank.

6. The modular horse bit according to claim 1, wherein:
the first sleeve includes a concaved pocket on one end surface; and
the second sleeve includes a concaved pocket on one end surface.

7. The modular horse bit according to claim 1, wherein the first shank is configured to be threaded into the first end cap, and wherein the second shank is configured to be threaded into the second end cap.

8. A modular horse bit, comprising:
a first mouthpiece comprising:
a first sleeve defining a first internal channel extending through at least a portion of a length of the first sleeve;
a first hook comprising a first hook shank configured to extend through the first internal channel, the first hook shank having a first threaded portion at one end and a curved hook portion at an opposite end;
a first end cap comprising a first hole with internal threads configured to engage with the first threaded portion of the first hook shank; and
a first cheek piece having a first cheek piece opening, the first cheek piece removably connected to the first mouthpiece;
a second mouthpiece comprising:
a second sleeve defining a second internal channel extending through at least a portion of a length of the second sleeve;
a second hook comprising a second hook shank configured to extend through the second internal channel, the second hook shank having a second threaded portion at one end and a curved hook portion at an opposite end;
a second end cap comprising a second hole with internal threads configured to engage with the second threaded portion of the second hook shank; and
a second cheek piece having a second cheek piece opening, the second cheek piece removably connected to the second mouthpiece;
wherein the curved hook portion of the first hook and the curved hook portion of the second hook are configured to engage with one another to connect the first mouthpiece to the second mouthpiece.

9. The modular horse bit according to claim 8, wherein:
the first sleeve comprises a first tapered pocket on an end surface of the first sleeve; and
the second sleeve comprises a second tapered pocket on an end surface of the second sleeve.

10. The modular horse bit according to claim 8, wherein:
when the first end cap is threaded into the first threaded portion of the first hook shank, the curved hook portion of the first hook is pulled into the first tapered pocket; and
when the second end cap is threaded into the second threaded portion of the second hook shank, the curved hook portion of the second hook is pulled into the second tapered pocket.

11. The modular horse bit according to claim 10, wherein:
when the curved hook portion of the first hook is pulled into the first tapered pocket, an opening in the curved hook portion of the first hook is partially covered by the end surface of the first sleeve; and
when the curved hook portion of the second hook is pulled into the second tapered pocket, an opening in the curved hook portion of the second hook is partially covered by the end surface of the second sleeve.

12. The modular horse bit according to claim 8, wherein:
the first end cap comprises two detents configured to receive ends of the first cheek piece; and
the second end cap comprises two detents configured to receive ends of the second cheek piece.

13. The modular horse bit according to claim 12, wherein:
the first cheek piece is configured to rotate at the first detents about an axis perpendicular to an axis of the first sleeve; and
the second cheek piece is configured to rotate at the second detents about an axis perpendicular to an axis of the second sleeve.

14. The modular horse bit according to claim 8, wherein:
the first cheek piece opening is larger than a diameter of the first hook shank and smaller than a diameter of the first end cap; and
the second cheek piece opening is larger than a diameter of the second hook shank and smaller than a diameter of the second end cap.

15. The modular horse bit according to claim 8, wherein the first sleeve and the second sleeve each have a generally cylindrical body that tapers toward a central joint region where the first mouthpiece connects to the second mouthpiece.

16. The modular horse bit according to claim 8, wherein the first cheek piece and the second cheek piece are each substantially circular in shape with an opening forming a C-shape configuration.

17. The modular horse bit according to claim 8, wherein the first tapered pocket and the second tapered pocket are each concave.

18. A kit for modular horse bit, the kit comprising:
a first mouthpiece comprising:
a first sleeve defining a first internal channel extending through at least a portion of a length of the first sleeve;
a first hook comprising a first hook shank sized to extend through the first internal channel, the first hook shank having a first threaded portion at one end and a curved hook portion at an opposite end;
a first end cap comprising a first hole with internal threads sized and configured to engage with the first threaded portion of the first hook shank; and
a first cheek piece having a first cheek piece opening, the first cheek piece configured to be removably connected to the first mouthpiece;
a second mouthpiece comprising:
a second sleeve defining a second internal channel extending through at least a portion of a length of the second sleeve;
a second hook comprising a second hook shank sized to extend through the second internal channel, the second hook shank having a second threaded portion at one end and a curved hook portion at an opposite end;
a second end cap comprising a second hole with internal threads sized and configured to engage with the second threaded portion of the second hook shank; and
a second cheek piece having a second cheek piece opening, the second cheek piece configured to be removably connected to the second mouthpiece.

19. The kit for modular horse bit according to claim 18, wherein
the first sleeve comprises a first tapered pocket on an end surface of the first sleeve; and
the second sleeve comprises a second tapered pocket on an end surface of the second sleeve

20. The kit for modular horse bit according to claim 18, wherein:
the first end cap comprises two detents configured to receive ends of the first cheek piece; and
the second end cap comprises two detents configured to receive ends of the second cheek piece.
